(19) United States
(12) Patent Application Publication
(10) Pub. No.: US 2012/0185527 A1
(43) Pub. Date: Jul. 19, 2012

(54) DISTRIBUTED VIRTUAL DESKTOP ARCHITECTURE

(75) Inventors: Joe Jaudon, Sedalia, CO (US); David Lowrey, Denver, CO (US); Adam Williams, Aurora, CO (US)

(73) Assignee: Aventura HQ, Inc., Denver, CO (US)

(21) Appl. No.: 13/334,936

(22) Filed: Dec. 22, 2011

Related U.S. Application Data
(60) Provisional application No. 61/426,320, filed on Dec. 22, 2010.

(51) Int. Cl. G06F 15/16

(52) U.S. Cl. 709/203

(57) ABSTRACT

Methods, systems, and devices are described for providing distributed virtual desktops. In these methods, systems, and devices, a first user is authenticated at a first machine communicatively coupled with a server computer system. A second machine communicatively coupled with the server computer system is selected to host an operating system session associated with the first user. Input/output functionality for the operating system session associated with the first user is assigned to the first machine, and the first machine is instructed to communicate with the second machine such that the input/output functionality provided by the first machine is mapped to the operating system session associated with the first user at the second machine.

### CROSS REFERENCES

The present application claims priority to U.S. Provisional Patent Application No. 61/426,320, filed Dec. 22, 2010, entitled “DISTRIBUTED VIRTUAL DESKTOP ARCHITECTURE,” which is incorporated by reference in its entirety for all purposes.

### BACKGROUND

This invention relates to computer network communication, and more particularly, to a distributed virtual desktop architecture. Various computer systems may use a thin-client or a virtual desktop display in conjunction with a centralized server computer system or mainframe, and also use traditional workstations and handheld devices.

Virtualization is a logical representation of a computer in software. By decoupling the physical hardware from aspects of operation, virtualization may provide more operational flexibility and increase the utilization rate of the underlying physical hardware. Although virtualization is implemented primarily in software, many modern microprocessors now include hardware features explicitly designed to improve the efficiency of the virtualization process.

In traditional architectures, a virtual desktop display can be served to client devices from a server computer system. The server may receive input and output over a network or other communication medium established between the device and the server. In some examples, a thin-client device may run web browsers or remote desktop software, such that significant processing may occur on the server.

A full-function server computer system can be a significant expense for companies deploying a virtual desktop architecture. Thus, there may be a need in the art for alternative system architectures that mitigate the need for such investments by better utilizing existing computing resources of the company.

### SUMMARY

Methods, systems, and devices are described for providing distributed virtual desktops by using a server computer system to map the input/output functionality at a first machine to an operating system session associated with a user hosted by a second machine.

In a first set of embodiments, a system includes multiple machines and a server computer system. Each machine may be configured to host at least one operating system session and provide an input/output functionality. The server computer system may be communicatively coupled with each of the machines. The server computer system may be configured to authenticate a first user at a first of the machines; select a second of the machines to host an operating system session associated with the first user; assign the first machine to provide input/output functionality for the operating system session associated with the first user; and instruct the first machine to communicate with the second machine such that the input/output functionality provided by the first machine is mapped to the operating system session associated with the first user at the second machine.

In a second set of embodiments, a method of providing a distributed virtual desktop includes authenticating a first user at a first machine communicatively coupled with a server computer system; selecting a second machine communicatively coupled with the server computer system to host an operating system session associated with the first user; assigning input/output functionality for the operating system session associated with the first user to the first machine; and instructing the first machine to communicate with the second machine such that the input/output functionality provided by the first machine is mapped to the operating system session associated with the first user at the second machine.

In a third set of embodiments, a method of providing distributed virtual desktops includes: receiving login credentials from a first user at a first machine; communicating with a server computer system to authenticate the user based on the login credentials; receiving a selection by the server computer system of a second machine to host an operating system session associated with the first user; and communicating with the second machine to map input/output functionality provided at the first machine to the operating system session associated with the first user at the second machine.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2A is a block diagram of an example system including components configured according to various embodiments of the invention.

FIG. 2B is a block diagram of an example system including components configured according to various embodiments of the invention.

FIG. 2C is a block diagram of an example system including components configured according to various embodiments of the invention.

FIG. 3 is a block diagram of an example system including components configured according to various embodiments of the invention.

FIG. 4 is a block diagram of an example system including components configured according to various embodiments of the invention.

FIG. 5 is a block diagram of an example table mapping input/output functionality for operating system sessions to machines implementing the operating system sessions, according to various embodiments of the invention.

FIG. 6A is a block diagram of an example server computer system according to various embodiments of the invention.

FIG. 6B is a block diagram of an example server computer system according to various embodiments of the invention.

FIG. 7 is a block diagram of an example machine according to various embodiments of the invention.

FIG. 8 is a flowchart diagram of an example method of providing a distributed virtual desktop according to various embodiments of the invention.

FIG. 9 is a flowchart diagram of an example method of providing a distributed virtual desktop according to various embodiments of the invention.

FIG. 10 is a flowchart diagram of an example method of providing a distributed virtual desktop according to various embodiments of the invention.

FIG. 11 is a flowchart diagram of an example method of providing a distributed virtual desktop according to various embodiments of the invention.

FIG. 12 a schematic diagram that illustrates a representative device structure that may be used in various embodiments of the present invention.

### DETAILED DESCRIPTION OF THE INVENTION

Methods, systems, and devices are disclosed for providing one or more distributed virtual desktops. Multiple machines may be communicatively coupled with a server computer system. Each machine may be capable of executing and hosting an operating system session and providing input/output functionality. The input/output functionality of each machine may be decoupled from any operating system session hosted by that machine. The server computer system may authenticate a user at a first machine, select a second machine to host an operating system session associated with the user, and assign the first machine to provide input/output functionality for the operating system session. The first machine may receive the instruction to communicate with the second machine such that the input/output functionality provided by the first machine is mapped to the operating system session at the second machine.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

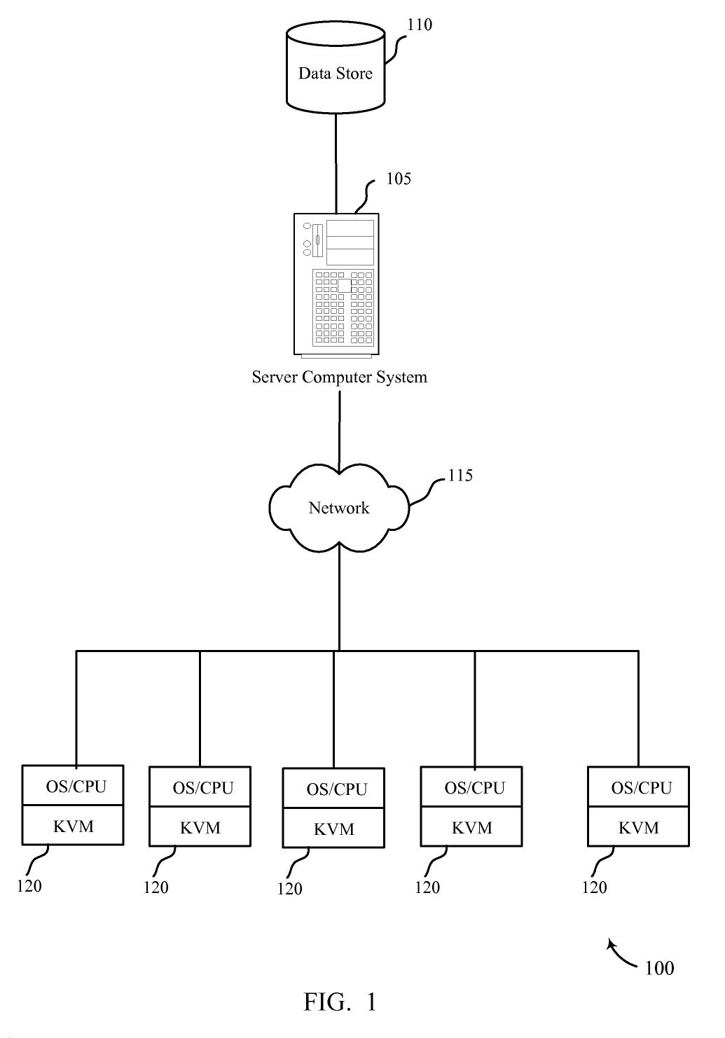

Systems, devices, methods, and software are described for a distributed virtual desktop architecture. In one set of embodiments, shown in FIG. 1, system 100 includes a server computer system 105, data store 110, network 115, and machines 120. Each of these components may be in communication with each other, directly or indirectly.

The machines 120 may communicate with each other over the network 115. Each of these networked machines 120 may each be configured to run one or more operating system sessions (e g , running the operating system (OS) using a CPU and memory) for one or more users, while the keyboard, video, and mouse (KVM) and/or other input/output functions are untied from the machine 120 running the session and allowed to roam with a user. The server computer system 105 may allocate sessions to specific machines 120 in the network. A machine 120 may be a personal computer, laptop, tablet, personal digital assistant (PDA), thin client, mobile device, cellular telephone, or any other computing device, and may have wired or wireless connections.

The server computer system 105 may include a session manager and rules engine to allocate and manage sessions within the network. The server computer system 105 may be made up of one or more server computers, workstations, web servers, or other suitable computing devices. The server computer system 105 may be fully located within a single facility or distributed geographically, in which case a network may be used to integrate different components. Although the illustrated embodiment shows that a separate server computer system 105 performs the allocation and management, in other examples these functions may be performed by a virtual server, resident in whole or in part on one of the machines 120, or distributed among machines 120.

The rules for allocating a user session to a particular machine 120 may be stored locally by the server computer system 105, or may be stored (in whole or in part) at data store 110. Data store 110 may be a single database, or may be made up of any number of separate and distinct databases. The data store 110 may include one, or more, relational databases or components of relational databases (e.g., tables), object databases, or components of object databases, spreadsheets, text files, internal software lists, or any other type of data structure suitable for storing data. Thus, it should be appreciated that a data store 110 may each be multiple data storages (of the same or different type), or may share a common data storage with other data stores. Although in some embodiments the data store 110 may be distinct from a server computer system 105, in other embodiments the data store 110 may be integrated into the server computer system 105 to varying degrees.

A user may log on to a machine 120 (e.g., with a password, a key card, key fob, biometric sign-in, etc.), and the machine 120 may query the server computer system 105 about the user. The server computer system 105 may direct an operating system session to be started on the machine 120 the user logged into, or on another machine 120. The machine's operating system, CPU, and memory may be partially or entirely decoupled from the keyboard, video, and mouse (KVM) functions, and/or other input/output functions, so that the user may have KVM and/or other input/output functionality at the machine 120 hosting the operating system session, or another machine 120. In certain examples, the KVM and/or other input/output functionality of a machine 120 to which the user has logged in may be entirely mapped to the machine 120 hosting the operating system session associated with the user. Alternatively, a portion of the KVM and/or other input/output functionality of the machine 120 to which the user has logged in may remain mapped to the machine to which the user has logged in for the purpose of logging in and out.

If the machine 120 hosting the operating system session is different from the machine 120 to which the user has logged in, the machine 120 to which the user has logged in may communicate with the machine 120 hosting the operating system session over the network 115 such that the KVM and/or other input/output functionality of the machine 120 to which the user has logged in is mapped to the operating system session associated with the user.

When a user logs out of a machine 120 providing the KVM or other input/output functionality for an operating system session, the operating system session may be maintained on the machine 120 running the session (e.g., for a system specified time period, a user-specified time period, a user specific time period, or indefinitely). The user may log on to a machine 120 (the same, or different computer, from the previous log on), and the machine 120 may query the server computer system 105 about the user. The server computer system 105 may direct a connection between the machine 120 running the session and the machine 120 where the user logged in. This connection can be direct between computers, through a network, or via the server computer system 105. The user may then have KVM or other input/output functionality on the machine 120 where he or she is logged in, while a different machine 120 is hosting the session.

In some embodiments, each machine 120 may be configured to run only one operating system session at a time (e.g., for purposes of complying with a license agreement). In other embodiments, a single machine 120 may run a number of operating system sessions, or a session may be distributed over multiple computers. In some embodiments, an operating system session may remain on a single machine 120 until the operating system session is terminated or removed. In other embodiments, aspects of the operating system session may be moved dynamically (i.e., balanced) among one or more of the machines 120 as a load on a system changes.

The components of the system 100 may be directly connected, or may be connected via the network 115. The network 115 may be any combination of the following: the Internet, an IP network, an intranet, a wide-area network (“WAN”), a local-area network (“LAN”), a virtual private network, the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically. If no specific means of connection is noted, it may be assumed that the link, communication, or other connection between devices may be via a network.

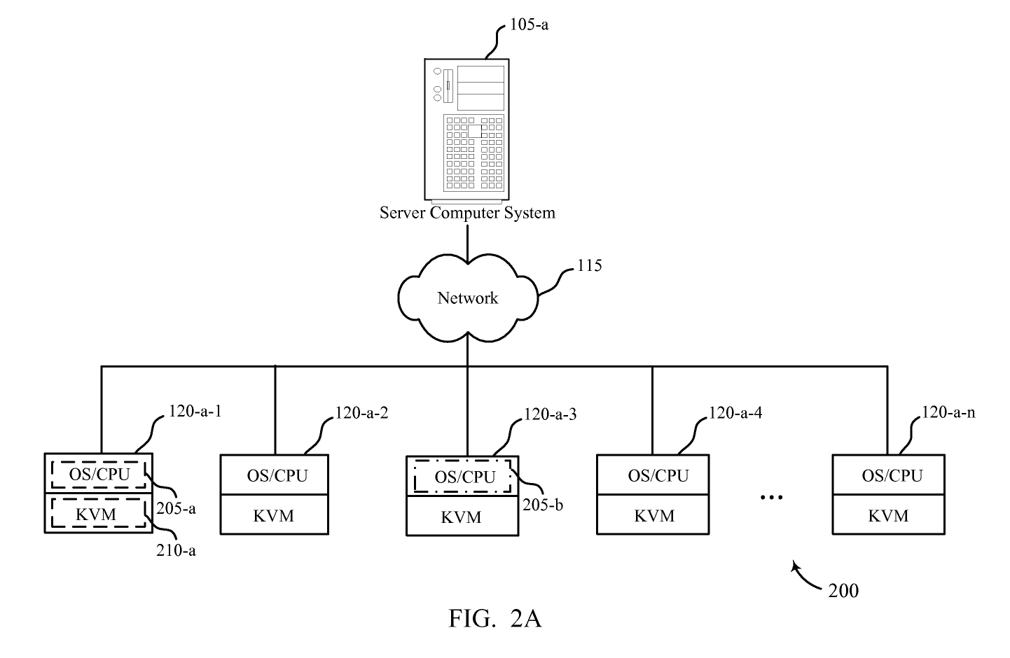

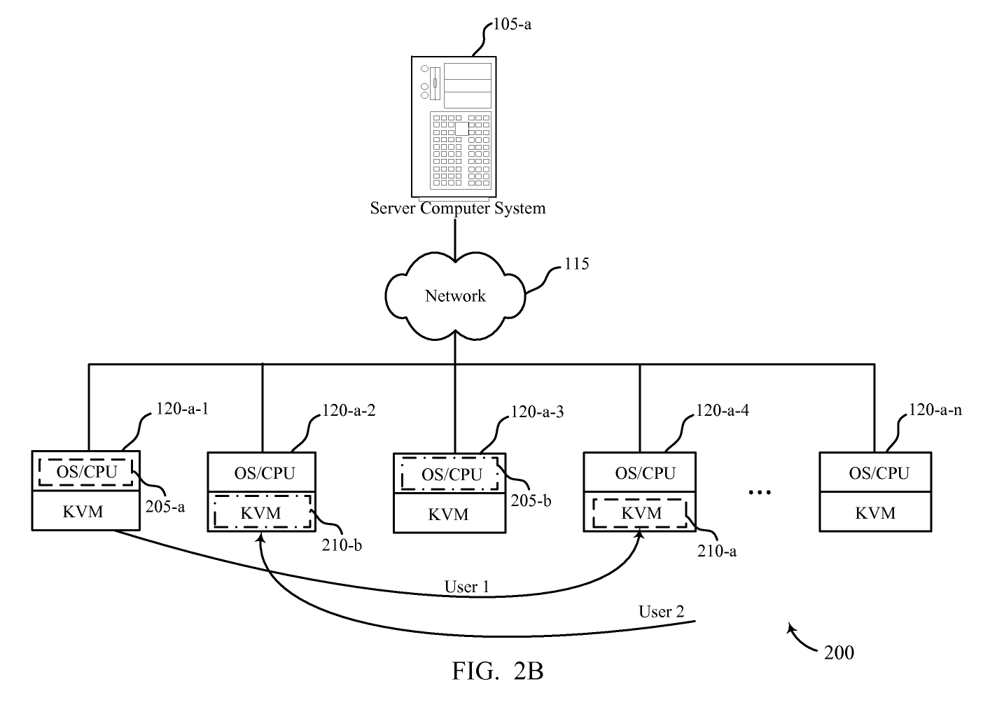

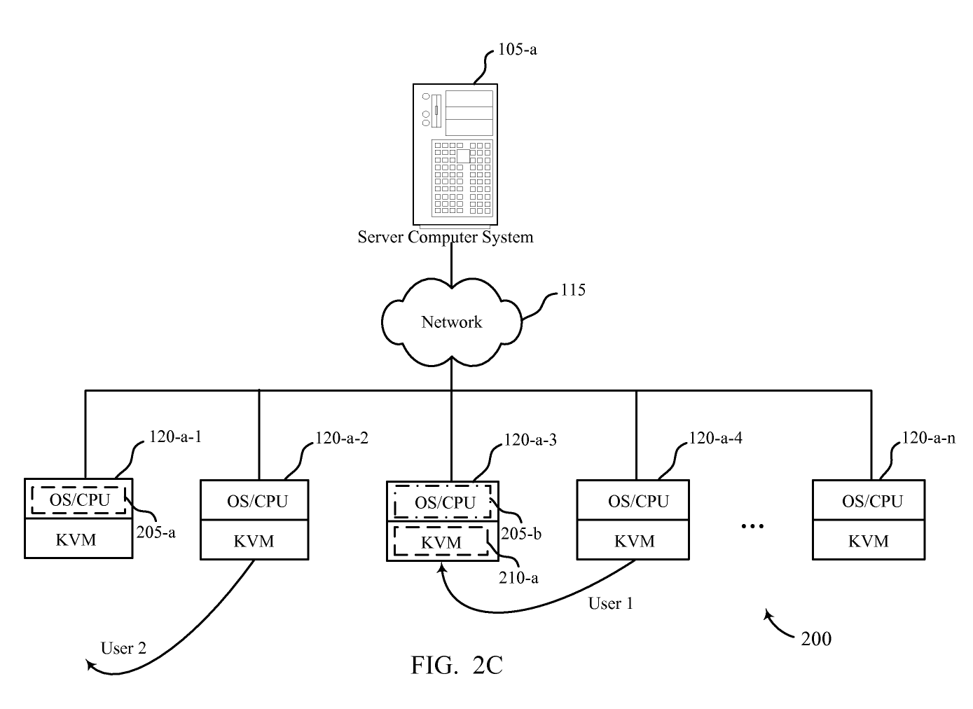

Turning next to FIGS. 2A-2C, these diagrams illustrate an example of the system 100 of FIG. 1. System 200 includes server computer system 105-a and machines 120. Each of these components may be in communication with each other, directly or indirectly. Referring first to FIG. 2A of the system 200 at an initial period of time, user 1 logs onto machine 120-a-1. The machine 120-a-1 may query the server computer system 105-a about the user, and the server computer system 105-a may authenticate the user and check to see if the user has a current operating system session running The server computer system 105-a may direct machine 120-a-1 to initialize an operating system session 205-a for user 1.

The operating system, CPU, and memory functions dedicated to that operating system session may be controlled independently from the keyboard, video, and mouse (KVM) functions 210-a of machine 120-a-1. Thus, while user 1 may at first access the operating system session 205-a associated with user 1 on the first machine 120-a-1 using the KVM functions 210-a of the first machine 120-a-1, the KVM functions 210-a of the first machine 120-a-1 may be separable from the operating system, CPU, and memory functions dedicated to that operating system session. For example, at a later time the KVM functions of another machine 120-a may be mapped to the first machine 120-a-1 to control operating system session 205-a, and the KVM functions of the first machine 120-a-1 may be mapped to control a different operating system session at a different machine 120-a.

As further shown in FIG. 2A, user 2 may have an operating system session 205-b running on machine 120-a-3. However, user 2 may not be currently logged into any of the machines 120-a, and thus none of the machines 120-a may be currently providing KVM functions to the operating system session 205-b associated with user 2.

Referring next to FIG. 2B of the system 200 at a later period of time, user 1 may log off of machine 120-a-1, move to machine 120-a-4, and log on to machine 120-a-4. The machine 120-a-4 may query the server computer system 105-a about user 1, and the server computer system 105-a may authenticate user 1 and determine that user 1 has a current operating system session 205-a running on machine 120-a-1. The server computer system 105-a may direct a connection to be made between machine 120-a-1 and machine 120-a-4. The KVM functions 210-a at machine 120-a-4 may then be mapped to the operating system session 205-a running on machine 120-a-1. Through the dynamic switching of KVM functionality facilitated by the server computer system 105-a, user 1 may access and control the operating system session 205-a running on the first machine 120-a-1 while user 1 is using the KVM controls of the fourth machine 120-a-4.

As further shown in FIG. 2B, user 2 may have a session 205-b running on machine 120-a-3, but log in at machine 120-a-2. The machine 120-a-2 may query the server computer system 105-a about user 2, and the server computer system 105-a may authenticate user 2 and determine that user 2 has a current session 205-b running on machine 120-a-3. The server computer system 105-a may direct a connection to be made between machine 120-a-2 and machine 120-a-3. The KVM functions 210-b at machine 120-a-2 may then be mapped to the operating system session 205-b running on machine 120-a-3, thereby allowing user 2 to access and control the operating system session 205-b running on machine 120-a-3 from machine 120-a-2.

Referring next to FIG. 2C of the system 200 at a still later period of time, user 2 may log off of machine 120-a-2, but the session 205-b associated with user 2 may be maintained on machine 120-a-3. User 1 may log off of machine 120-a-4, moving to machine 120-a-3 and log back on at machine 120-a-3. The machine 120-a-3 may query the server computer system 105-a about the user, and the server computer system 105-a may authenticate the user and determine that the user still has a current session 205-a running on machine 120-a-1. The server computer system 105-a may direct a connection to be made between machine 120-a-1 and machine 120-a-3, such that the KVM functions 210-a of machine 120-a-3 are mapped to the operating system session 205-a running on machine 120-a-1.

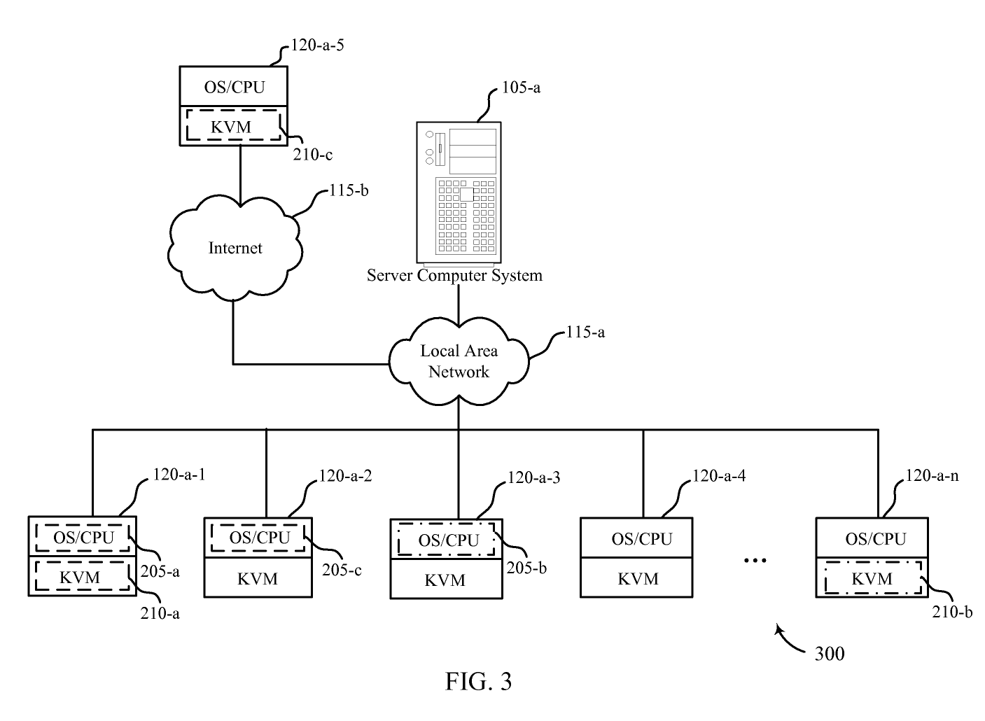

FIG. 3 illustrates another example of a system 300 for distributing desktops. The system 300 may be an example of the system 100 or 200 described above with reference to FIG. 1 or FIG. 2. The system 300 includes server computer system 105-a, local area network 115-a, the Internet 115-b, and machines 120-a.

In the present example, machines 120-a-1 through 120-a-n, with the exception of remote machine 120-a-5, are communicatively coupled with local area network 115-a. The remote machine 120-a-5 may be indirectly coupled to the other machines 120-a via the Internet 115-b and the local area network 115-a. In certain examples, the remote machine 120-a-5 may be assigned to a remote user who does not have direct access to the local area network 115-a. As shown in FIG. 3, a first operating system session 205-a may be hosted on the operating system, CPU, and memory of machine 120-a-1, and KVM functionality 210-a for the first operating system session 210-a may also be provided by machine 120-a-1. A second operating system session 205-b may be hosted by the operating system, CPU, and memory of machine 120-a-3, and the KVM functionality 210-b for the second operating system session 205-b may be provided by machine 120-a-n.

A third operating system session 205-b may be hosted by the operating system, CPU, and memory of machine 120-a-3, and the KVM functionality 210-a for the third operating system session 205-c may be provided by machine 120-a-5 over the local area network 115-a and the Internet 115-b. Input/output functionality from machine 120-a-5 may be mapped to the third operating system session 205-b using, for example, Internet Protocol (IP) packets. In certain examples, one or more KVM over IP devices may be used to translate KVM functionality at the remote machine 120-a-5 over the networks 115.

In one example, user 3 may log into the server computer system 105-a with remote machine 120-a-5 over the Internet 115-b and/or the local area network 115-a. The server computer system 105-a may initiate an operating system session 205-c for user 3 at machine 120-a-2 or determine that an operating system session 205-c associated with user 3 already exists at machine 120-a-2. The server computer system 105-a may then facilitate the establishment of a session between the remote machine 120-a-5 and machine 120-a-2 such that KVM or other input/output functionality from the remote machine 120-a-5 is mapped to the operating system session 205-c running on machine 120-a-2.

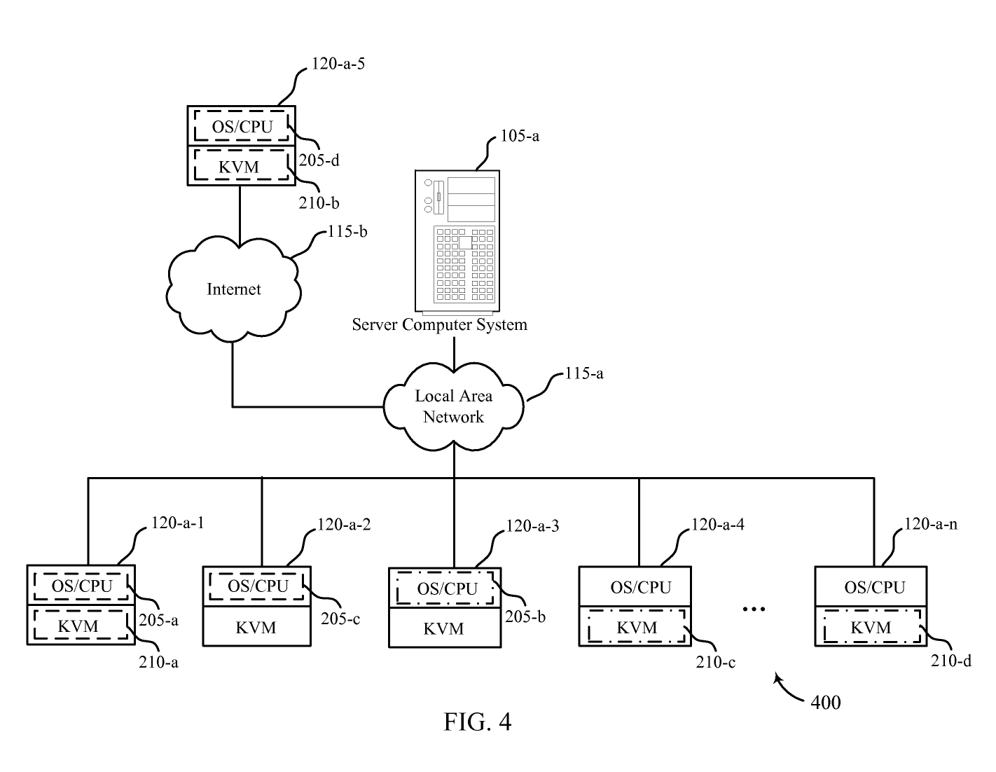

FIG. 4 illustrates another example of a system 400 for distributing desktops. The system 400 may be an example of the system 200 described above with reference to FIG. 2.

The system 400 includes server computer system 105-a, local area network 115-a, the Internet 115-b, and machines 120-a.

Similar to the example of FIG. 3, machines 120-a-1 through 120-a-n, with the exception of remote machine 120-a-5, are communicatively coupled with local area network 115-a, and the remote machine 120-a-5 is indirectly coupled to the other machines 120-a via the Internet 115-b and the local area network 115-a. As shown in FIG. 4, a first operating system session 205-a may be hosted on the operating system, CPU, and memory of machine 120-a-1, and KVM functionality 210-a for the first operating system session 210-a may also be provided by machine 120-a-1. A second operating system session 205-b may be hosted by the operating system, CPU, and memory of machine 120-a-3, and the KVM functionality 210-b for the second operating system session 205-b may be provided by machine 120-a-n. A third operating system session 205-b may be hosted by the operating system, CPU, and memory of machine 120-a-3, and the KVM functionality 210-a for the third operating system session 205-c may be provided by machine 120-a-5 over the local area network 115-a and the Internet 115-b.

A fourth operating system session 205-d may be hosted by the operating system, CPU, and memory of remote machine 120-a-5, and the KVM functionality for the fourth operating system session 205-d may be provided by machine 120-a-n. The KVM functionality of machine 120-a-n may be mapped to the fourth operating system session 205-d over the local are network 115-a and the Internet 115-b. Thus, the KVM functionality of remote machine 120-a-5 may be decoupled from the operating system, CPU, and memory of to allow for the dynamic virtual distribution of operating system sessions among users of the different machines 120-a.

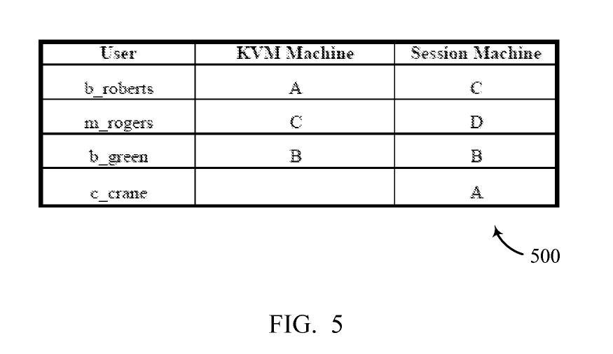

FIG. 5 is a diagram of an example of a mapping table 500 that may be used to track multiple operating system sessions, and to map KVM or other input/output functionality from each machine hosting an authenticated user to the machine hosting a corresponding operating system session for that authenticated user. The mapping table 500 may be maintained, for example, by the server computer system 105 of FIG. 1, FIG. 2A, FIG. 2B, FIG. 2C, FIG. 3, or FIG. 4. The mapping table may be stored in a data store (e.g., data store 110 of FIG. 1) associated with and/or implemented within the server computer system 105.

As shown in the example of FIG. 5, authenticated user b_roberts may be currently logged in at machine A, which may provide KVM functionality to an operating system session for user b_roberts at machine C. Thus, the KVM functions of machine A may be at least partially detached from the CPU, operating system, and memory of machine A, and mapped to machine C. This mapping may occur over a direct connection between machine A and machine C and/or a network connection. In this way, user b_roberts may transparently access and control his or her operating system session on machine C from machine A as though machine A were hosting the operating system session.

As further shown in the example of FIG. 5, authenticated user m_rogers may use machine C to access an operating system session hosted by machine D. The KVM functionality of machine C may be mapped to the operating system session associated with user m_rogers at machine D. User b_green may access an operating system session hosted by machine B at machine B. Thus, the KVM functionality of machine B may be mapped to the operating system session associated with user b_green at machine B. In the case of user c_crane, a session may be hosted on machine A, but the user may not be currently logged in or authenticated at any machine. Consequently, no KVM functionality may be mapped to the session associated with user c_crane at machine A at present.

The table 500 shown in FIG. 5 may be dynamically updated as changes occur in the system. For example, whenever a new operating system session is created for a particular user, the machine hosting the operating system session for that user may be recorded in the mapping table 500. Additionally, whenever an operating system session associated with a particular user is terminated, the machine hosting that operating system session may be removed from the listing associated with the user in the table 500. Moreover, as users log on and off of machines and the machines providing KVM functionality to individual operating system sessions change, these changes may be dynamically updated within the table 500.

The table 500 may be used by the server computer system to determine the appropriate action to take when a user logs on or off of a particular machine. For example, each time the server computer system authenticates login credentials received from a user at a machine in the network, the server computer system may search the table 500 to determine whether an entry for that user exists. If an entry exists for that user, the server computer system may identify a machine hosting a previously initiated operating system session associated with that user. If such an operating system session exists and KVM functionality is separable at the machine to which the user has logged in, the server computer system may instruct the machine to which the user has logged in to communicate with the machine hosting the operating system session.

Through this communication, the KVM functionality of the machine to which the user has logged in may be mapped to the operating system session associated with the user at the machine hosting the operating system session. Thus, the user may control the operating system session at the machine to which the user has logged in, and it may appear to the user as if the machine to which the user has logged in is hosting the operating system session associated with the user. In conjunction with this mapping, the server computer system may update the table 500 to reflect that the KVM machine to which the user has logged in is now mapped to the machine hosting the operating system session associated with the user.

The table 500 shown in FIG. 5 may also be used by the server computer system to prevent conflicts for the same resources from competing users or operating system sessions. For example, as shown in FIG. 5, machine D may host an operating system session for user m_rogers, but may not be providing KVM services to any user. Thus, machine D may appear to be open for a new user to log in. However, an operating system licensing agreement may prevent machine D from hosting more than one operating system session at a time.

If a user without an existing operating system session logs into machine D, the server computer system may identify from the table 500 that machine D is unavailable to host an operating system session, initiate an operating system session for the user at another machine (e.g., machine E), map the KVM functionality of machine D to machine E, and update the table 500 accordingly. Additionally or alternatively, the server computer system may suspend or terminate a running operating system session for a user that is not logged into any machine (e.g., user c_crane in FIG. 5) to free up resources for the user logging in.

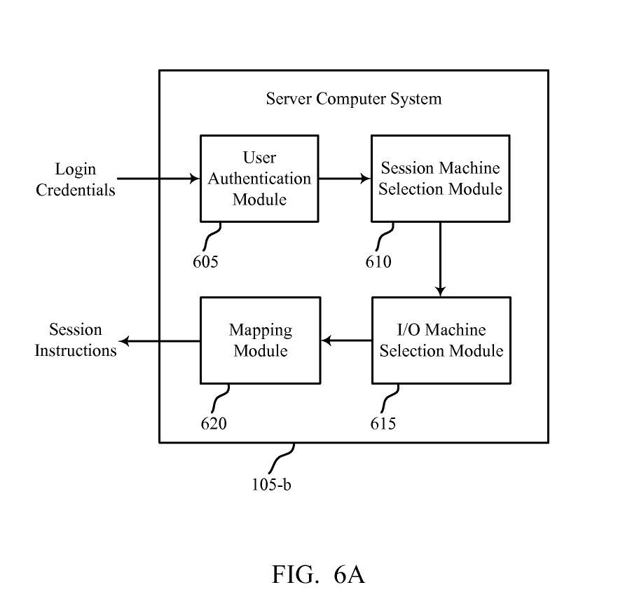

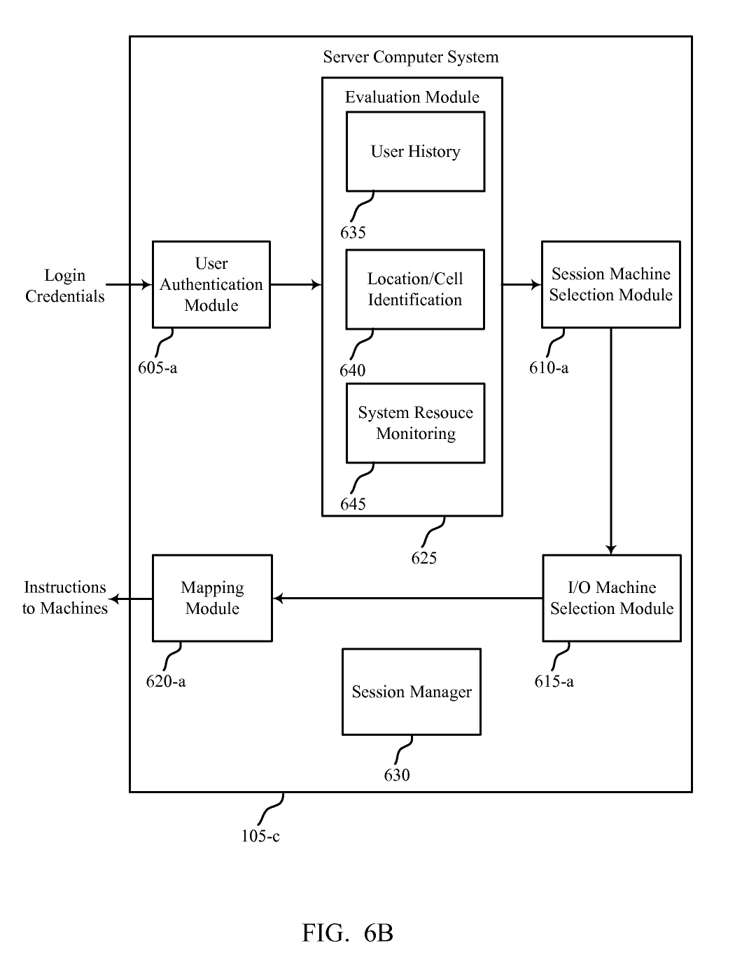

FIG. 6A illustrates an example of a server computer system 105-b consistent with the principles described above. The server computer system 105-b may be an example of the server computer system 105 described above with reference to FIG. 1, FIG. 2A, FIG. 2B, FIG. 2C, FIG. 3, or FIG. 4.

As shown in FIG. 6A, the server computer system 105-b of the present example includes a user authentication module 605, a session machine selection module 610, an input/output machine selection module 615, and a mapping module 620. Each of these components may be in communication, directly or indirectly. In certain examples, one or more of the modules 605, 610, 615, 620 of the server computer system 105-b may be implemented by hardware configured to execute special-purpose code. Additionally or alternatively one or more of the modules 605, 610, 615, 620 of the server computer system 105-b may be implemented by hardware alone.

The server computer system 105-b may communicate with a plurality of machines, each of which may be configured to execute and host at least one operating system session and provide input/output functionality to at least one operating system session. For at least some of the machines, the input/output functionality may be implemented independently from the at least one operating system session such that a first machine is capable of hosting a first operating system session, with input/output functionality of the first operating system session being controlled by a second machine, while the first machine concurrently provides input/output functionality to a second operating system session hosted by a third machine.

The user authentication module 605 may be configured to communicate with a machine to authenticate a user at the machine. For example, the user may provide a username, password, key card credentials, key fob credentials, biometric credentials, and/or other credentials to the machine, which may be received at the user authentication module 605 to verify the identity of the user. The credentials received for the user at the user authentication module 605 may be associated with a system used by the server computer system 105-b to manage operating system sessions. In certain examples, the credentials may be associated with a user account in an enterprise network.

Once the user at the machine has been authenticated by the user authentication module 605, the session machine selection module 610 may select one of the machines communicatively coupled with the server computer system 105-b to host an operating system session for the user. In certain examples, the selection of a machine to host the operating system session for the user may be based on a determination of whether a previously initiated operating system session already exists for the user. For example, the session machine selection module 610 may determine that an operating system session associated with the user is already exists on a second machine. In this example, the session machine selection module 610 may elect to allow the second machine to continue hosting the operating system session, thereby selecting the second machine as the host for the operating system session associated with the user.

In other examples, the session machine selection module 610 may determine that a previously initiated operating system session exists for the user, but the previously initiated operating system session may be inadequate for an intended purpose, or expired. Alternatively, the session machine selection module 610 may determine that no operating system session for the user is currently running In such examples, the session machine selection module 610 may elect a machine to host a new operating system session associated with the user. In certain examples, when a new operating system session is elected, any existing operating system session that is also associated with the user may be terminated or suspended.

To select a machine to host a new operating system session for the user, the session machine selection module 610 may examine a record of current machines and operating system sessions to identify an available host for the new operating system session. In certain examples, this record may include a table such as the table 500 shown in FIG. 5. First priority may be given to the machine on which the user is logged in, if that machine is available. Otherwise, another available machine may be selected to host the operating system session for the user. The session machine selection module 610 may make a record of the machine selected to host the operating system session.

Where a new operating system session is to be created for the user, the session machine selection module 610 may be configured to instantiate the operating system session at the selected host machine. In certain examples, this may include retrieving one or more user profile files associated with the user from a data store or other repository and providing the user profile files to the machine hosting the operating system session for the user. In certain examples, a specific type of operating system (e.g., Windows, Linux, OS/X, Unix, etc.) may be selected and instantiated for the operating system session. In some embodiments, a new virtual machine may be spun up at the host machine to implement the operating system session.

The input/output machine selection module 615 may be configured to select a machine to provide input/output functionality (e.g., KVM functionality) for the operating system session associated with the user. In many cases, the input/output machine selection module 615 may automatically select the machine on which the user is logged in to provide the input/output functionality. For example, if a user provides login credentials at a first machine, the server computer system 105-b may assume that the user intends to stay at the first machine and select the first machine to provide KVM functionality to the operating system session for the user. However, in alternative embodiments, a different machine may be selected to provide input/output functionality to the operating system session for the user.

The mapping module 620 may be configured to map the input/output functionality of the machine selected at the input/output machine selection module 615 to the operating system session hosted by the machine selected at the session machine selection module 610. The mapping module 620 may accomplish this mapping by instructing the machine selected by the input/output machine selection module 615 to communicate with the machine selected by the session machine selection module 610 directly or over a network. For example, the mapping module 620 may instruct the machine selected to provide input/output functionality to establish a connection with the machine selected to host the operating system session over a network, such that the user may control the operating system session at the machine selected to provide input/output functionality.

FIG. 6B illustrates another example of a server computer system 105-c consistent with the principles described above. The server computer system 105-c of FIG. 6B may be an example of the server computer system 105 described above with reference to FIG. 1, FIG. 2A, FIG. 2B, FIG. 2C, FIG. 3, FIG. 4, or FIG. 6B.

As shown in FIG. 6B, the server computer system 105-c of the present example includes a user authentication module 605-a, a session machine selection module 610-a, an input/output machine selection module 615-a, a mapping module 620-a, an evaluation module 625, and a session manager 630. Each of these components may be in communication, directly or indirectly. In certain examples, one or more of the modules 605-a, 610-a, 615-a, 620-a, 625, 630 of the server computer system 105-b may be implemented by hardware configured to execute special-purpose code. Additionally or alternatively one or more of the modules 605-a, 610-a, 615-a, 620-a, 625, 630 of the server computer system 105-b may be implemented by hardware alone.

The user authentication module 605-a, the session machine selection module 610-a, the input/output machine selection module 615-a, and the mapping module 620-a may be examples of the user authentication module 605, session machine selection module 610, input/output machine selection module 615, and mapping module 620 described above, respectively, with reference to FIG. 6A. Thus, the user authentication module 605-a may authenticate a user of a machine, the session machine selection module 610-a may select a machine to host an operating system session for the user (and, in some examples, initiate the operating system session), and the input/output machine selection module 615-a may select a machine to provide input/output functionality to the operating system session for the user. The mapping module 620-a may map the input/output functionality of the machine selected at the input/output machine selection module 615-a to the operating system session hosted for the user by the machine selected at the session machine selection module 610-a.

The evaluation module 625 may gather information about the user, machines, or system that may be used by the session machine selection module 610-a to select a machine to host the operating system session for the user and/or by the input/output machine selection module 615-a to select a machine to provide input/output functionality to the operating system session for the user. To this end, the evaluation module 625 may include a user history submodule 635, a location/cell identification submodule 640, and a system resource monitoring submodule 645.

For example, the user history submodule 635 may evaluate whether the user currently has an active operating system session, and where current active operating system session is located and/or where past operating system sessions were located. The location/cell identification submodule 640 may use various location determination techniques to determine the location and/or machine from which the user is logging on, and whether that machine or location is associated with any cell or group for allocation purposes. The system resource monitoring submodule 645 may monitor available resources associated with the various machines, including licensing restrictions, to determine appropriate candidates for hosting the operating system session or providing input/output functionality to the operating system session.

The session manager module 630 may include an Application Programming Interface (API) architecture which serves as the communication control point, managing existing operating system sessions and brokering new operating system sessions. The server computer system 105-c may include a centralized management console (not shown), which may be a web-based management console for configuration, real-time monitoring, and reporting. Additional management capabilities may exist for the entire virtual desktop/application distribution environment. It is worth noting that while the system has been described as a whole, individual aspects may be broken out and used exclusive of other aspects of the system.

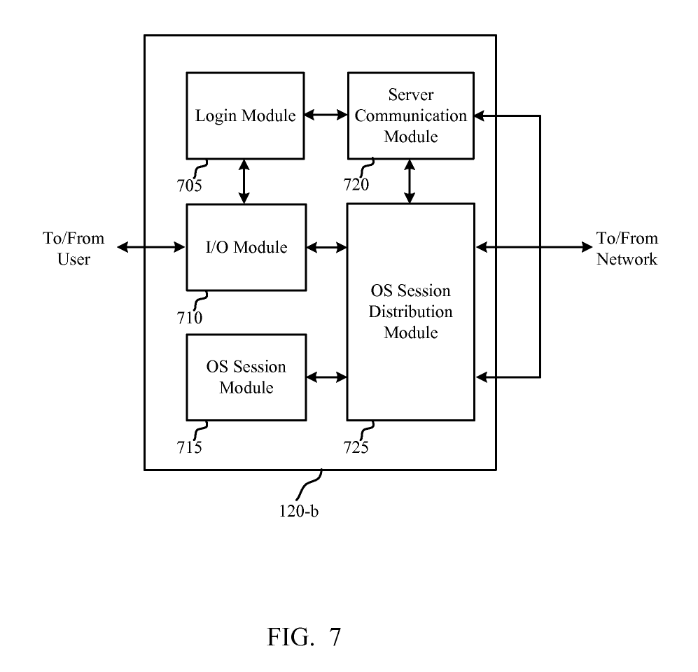

FIG. 7 illustrates an example of a machine 120-b that may be used to host an operating system session and/or provide input/output functionality to an operating system session consistent with the principles described above. The machine 120-b of FIG. 7 may be an example of the machine 120 described above with reference to FIG. 1, FIG. 2A, FIG. 2B, FIG. 2C, FIG. 3, or FIG. 4.

As shown in FIG. 7, the machine 120-b of the present example includes a login module 705, an input/output module 710, an operating system session module 715, a server communication module 720, and an operating system session distribution module 725. Each of these components may be in communication, directly or indirectly. In certain examples, one or more of the modules 705, 710, 715, 720, 725 of the machine 120-b may be implemented by hardware configured to execute special-purpose code. Additionally or alternatively one or more of the modules 705, 710, 715, 720, 725 of the machine 120-b may be implemented by hardware alone.

The login module 705 of the machine 120-b may be configured to receive login credential from a user of the machine 120-b. The login credentials may include, but are not limited to, a username, password, keycard credentials, key fob credentials, and biometric credentials. The login credentials may identify the user of the machine 120-b to a server computer system (e.g., the server computer system 105 described above with reference to FIG. 1, 2A, 2B, 2C, 3, 4, 6A, or, 6B). The server communication module 720 may transmit the received login credentials to the server computer system to authenticate the user.

If the user is authenticated based on the credentials provided, the server communication module 720 may communicate with the server computer system to identify a machine to host an operating system session for the user. In certain examples, an operating system session associated with the user may already exist on another machine. In such cases, the server may identify the other machine as the host for the operating system session for the user. Additionally or alternatively, the server may identify a machine for instantiating a new operating system session for the user. The machine identified for instantiating the new operating system may be machine 120-b, or another machine.

The input/output module 710 of the machine 120-b may provide input/output functionality to the user. For example, the input/output module may include peripheral devices and drivers to interface with the user. In certain examples, the input/output module 710 may include a keyboard, monitor or other display device, and mouse or other cursor device to provide KVM functionality to the user. In certain examples, a single device such as a touchscreen may implement one, more, or all input/output functions. The input/output module 710 may serve as an interface between the user and the login module 705 when the user logs in to the machine 120-b or a network. Once a machine has been identified as a host for an operating system session for the user, the operating system distribution module 725 may map the input/output module 710 to the operating system session. If the operating system session is hosted at a machine other than 120-b, this mapping may occur over a network or direct connection between the machine 120-b and the external host machine.

The operating system session module 715 may be configured to host one or more operating system sessions associated with individual users. The operating system session hosted by the operating system session module 715 may include an operating system session for the user of the machine 120-b or for a user of another machine. Because the input/output module 710 may be independent from the operating system session module 715, the input/output module 710 may be mapped to the operating system session module 715 of the present machine 120-b or detached completely from the operating system session module 715 of the present machine 120-b and mapped to an operating system session hosted by an external machine.

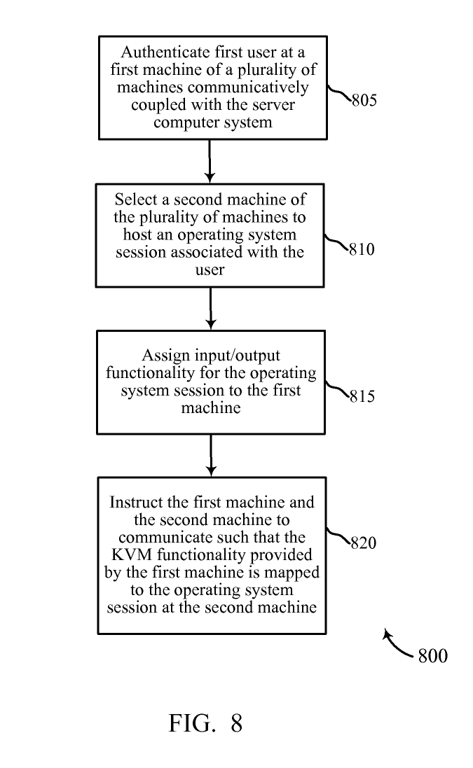

FIG. 8 is a flowchart diagram of an example method 800 of providing distributed virtual desktops. The method 800 may be implemented, for example, at a server computer system such as the server computer system 105 described above with reference to FIG. 1, FIG. 2A, FIG. 2B, FIG. 2C, FIG. 3, FIG. 4, FIG. 6A, or FIG. 6B.

At block 805, a user at a first machine of a plurality of machines communicatively coupled with the server computer system is authenticated. At block 810, a second machine of the plurality of machines is selected to host an operating system session associated with the first user. In certain examples, it may be determined that an operating system session associated with the first user is already in existence and hosted at the second machine. In such examples, the second machine may be selected to continue hosting the operating system session associated with the first user. Additionally or alternatively, selecting the second machine may include instructing the second machine to instantiate the operating system session associated with the first user.

At block 815, input/output functionality for the operating system session associated with the first user is assigned to the first machine. In certain examples, the input/output functionality may include KVM functionality. At block 820, the first machine is instructed to communicate with the second machine such that the input/output functionality provided by the first machine is mapped to the operating system associated with the first user at the second machine. The mapping may be implemented over a network connection (e.g., KVM over IP) or with a direct connection (e.g., a KVM switch). In certain examples, at least one record of the selection at block 810 and the assignment at block 815 may be maintained at a data store and dynamically updated as assignments change.

In certain examples, the method 800 may further include determining that the first user has logged out of the operating system session and removing a mapping between the input/output functionality of the first machine and the operating system session associated with the first user at the second machine. The mapping may be removed dynamically in response to the user logging out of the operating system session. Where the mapping has been removed, the second machine may, in certain examples, be allowed to continue running the operating system session associated with the first user.

In certain examples, the method 800 may further include authenticating the first user at a third machine and instructing the third machine to communicate with the second machine such that the input/output functionality provided by the third machine is mapped to the operating system session of the second machine. Such examples may allow the user to switch machines and dynamically access his or her operating system session on a new machine without removing or porting the operating system session from the second machine.

In additional or alternative examples, the method 800 may also include selecting the first machine to host a second operating system session associated with a second user. This hosting may occur while the first machine simultaneously provides input/output functionality to the operating system session associated with the first user. Additionally, a fourth machine may be assigned to provide input/output functionality to the second operating system session hosted at the first machine. The server computer system may instruct the first machine to communicate with the fourth machine to implement input/output functionality for the second operating system session at the fourth machine.

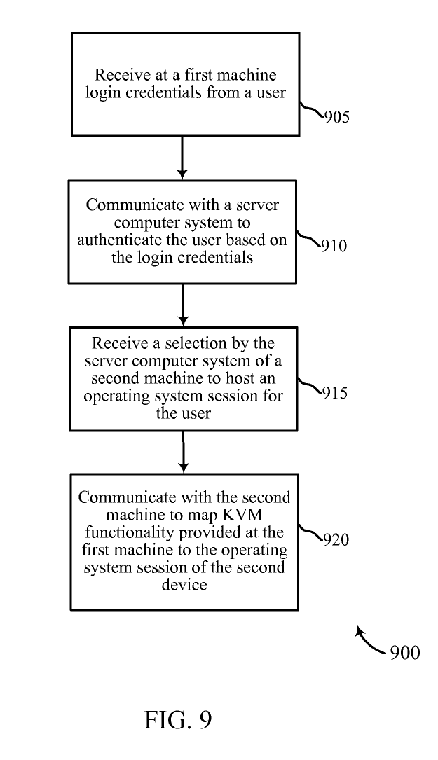

FIG. 9 is a flowchart diagram of an example method 900 of providing distributed virtual desktops. The method 900 may be implemented, for example, at a machine such as the machine 120 described above with reference to FIG. 1, FIG. 2A, FIG. 2B, FIG. 2C, FIG. 3, FIG. 4, or FIG. 7.

At block 905, login credentials are received at a first machine from a user. At block 910, the first machine communicates with a server computer system to authenticate the user based on the login credentials. At block 915, a selection by the server computer system of a second machine to host an operating system session for the user is received. At block 920, the server computer system communicates with the first machine and the second machine to map input/output functionality (e.g., KVM functionality) provided at the first machine to the operating system session associated with the user hosted by the second machine. In the example shown in FIG. 9, authentication of the user may occur prior to mapping the input/output functionality provided at the first machine to the operating system session hosted by the second machine. However, it should be understood that alternatively, the mapping may begin or complete prior to authentication of the user. In certain examples, the server computer system may identify the user prior to the mapping (e.g., identifying the user and associating the user with the first machine, or associating the user with a location), begin the mapping, and then authenticate the user during the mapping or after mapping the mapping has begun or finished. Doing so may provide the user faster access to the operating system session.

In certain examples, the method 900 may further include hosting an operating system session associated with a second user at the first machine while the input/output functionality of the first machine is mapped to the operating system session associated with the first user at the second machine. In such examples, the first machine may additionally communicate with a third machine to map input/output functionality of the third machine to the operating system session associated with the second user hosted by the first machine.

In additional or alternative examples, the method 900 may include receiving notification that the second user has logged off of the third machine and removing the mapping between the input/output functionality of the third machine and the operating system session associated with the second user hosted by the first machine. After the mapping is removed, the first machine may continue to run the operating system session associated with the second user.

In additional or alternative examples, the method 900 may include allowing the first user to log off of the first machine. The server computer system may be notified that the first user has logged off of the first machine, and the mapping between the input/output functionality of the first machine and the operating system session associated with the first user may be removed.

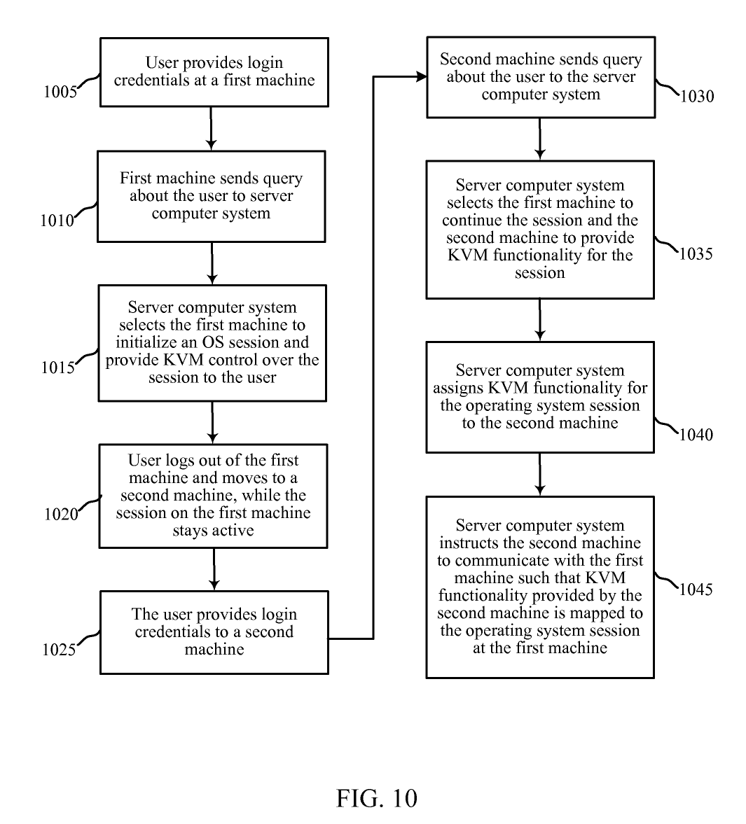

FIG. 10 is a flowchart diagram of an example method 1000 of providing distributed virtual desktops. The method 1000 may be implemented, for example, at a server computer system 105 such as the server computer system described above with reference to FIG. 1, FIG. 2A, FIG. 2B, FIG. 2C, FIG. 3, FIG. 4, or FIG. 7, at a machine such as the machine 120 described above with reference to FIG. 1, FIG. 2A, FIG. 2B, FIG. 2C, FIG. 3, FIG. 4, or FIG. 7, and/or at a system 100, 200, 300, 400 such as the system described above with reference to FIG. 1, FIG. 2A, FIG. 2B, FIG. 2C, FIG. 3, or FIG. 4.

At block 1005, a user provides login credentials at a first machine. At block 1010, the first machine sends a query about the user to a server computer system. At block 1015, the server computer system selects the first machine to initialize an operating system session associated with the first user and provide KVM control over the operating system session to the user. At block 1020, the user logs out of the first machine and moves to a second machine, while the session on the first machine stays active. At block 1025, the user provides login credentials to a second machine.

At block 1030, the second machine sends a query about the user to the server computer system. At block 1035, the server computer system selects the first machine to continue the operating system session associated with the user and the second machine to provide KVM functionality for the operating system session associated with the user. At block 1040, the server computer system assigns KVM functionality for the operating system to the second machine. At block 1045, the server computer system instructs the second machine to communicate with the first machine such that KVM functionality provided by the second machine is mapped to the operating system session at the first machine.

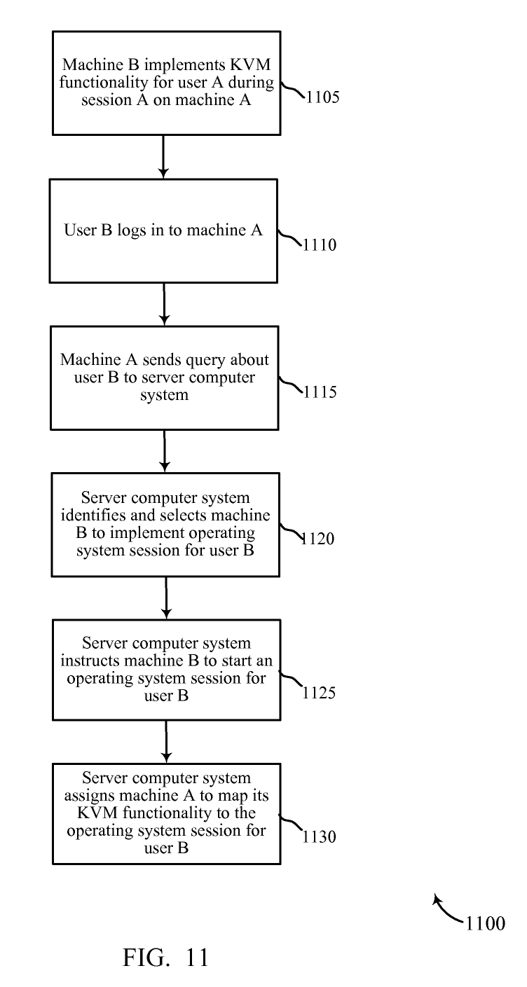

FIG. 11 is a flowchart diagram of an example method 1100 of providing distributed virtual desktops. The method 1100 may be implemented, for example, at a server computer system 105 such as the server computer system described above with reference to FIG. 1, FIG. 2A, FIG. 2B, FIG. 2C, FIG. 3, FIG. 4, or FIG. 7, at a machine such as the machine 120 described above with reference to FIG. 1, FIG. 2A, FIG. 2B, FIG. 2C, FIG. 3, FIG. 4, or FIG. 7, and/or at a system 100, 200, 300, 400 such as the system described above with reference to FIG. 1, FIG. 2A, FIG. 2B, FIG. 2C, FIG. 3, or FIG. 4.

At block 1105, machine B implements KVM functionality for user A during session A on machine A. At block 1110, user B logs in to machine A. At block 1115, machine A sends a query about user B to a server computer system. At block 1120, the server computer system identifies and selects machine B to implement an operating system session for user B. At block 1125, the server computer system instructs machine B to start an operating system session for user B. At block 1130, the server computer system assigns machine A to map its KVM functionality to the operating system session for user B.

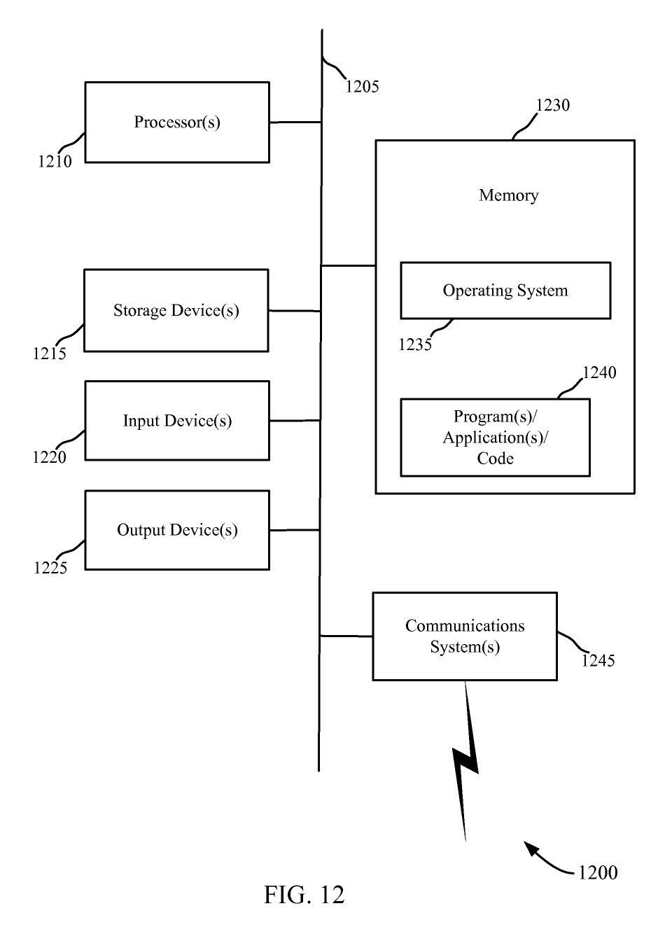

A device structure 1200 that may be used for a server computer system 105, a machine 120, or other computing devices described herein, is illustrated with the schematic diagram of FIG. 12. This drawing broadly illustrates how individual system elements of each of the aforementioned devices may be implemented, whether in a separated or more integrated manner. The exemplary structure is shown comprised of hardware elements that are electrically coupled via bus 1205, including processor(s) 1210 (which may further comprise a DSP or special-purpose processor), storage device(s) 1215, input device(s) 1220, and output device(s) 1225. The storage device(s) 1215 may be a machine-readable storage media reader connected to any machine-readable storage medium, the combination comprehensively representing remote, local, fixed, or removable storage devices or storage media for temporarily or more permanently containing computer-readable information. The communications systems interface 1245 may interface to a wired, wireless, or other type of interfacing connection that permits data to be exchanged with other devices. The communications system(s) 1245 may permit data to be exchanged with a network.

The structure 1200 may also include additional software elements, shown as being currently located within working memory 1230, including an operating system 1235 and other code 1240, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

The components described herein may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be hosted by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for providing distributed virtual desktops, the system comprising:
a plurality of machines, each machine being configured to host at least one operating system session and provide an input/output functionality; and
a server computer system communicatively coupled with each of the machines, wherein the server computer system is configured to:
authenticate a first user at a first machine of the plurality of machines;
select a second machine of the plurality of machines to host an operating system session associated with the first user;
assign the first machine to provide input/output functionality for the operating system session associated with the first user; and
instruct the first machine to communicate with the second machine such that the input/output functionality provided by the first machine is mapped to the operating system session associated with the first user at the second machine.

2. The system of claim 1, wherein the server computer system is further configured to:
determine that the first user has logged out of the operating system session;
allow the second machine to continue running the operating system session;
authenticate the first user at a third machine; and
instruct the third machine to communicate with the second machine such that the input/output functionality provided by the third machine is mapped to the operating system session of the second machine.

3. The system of claim 1, wherein the server computer system is further configured to:
select the first machine to host a second operating system session associated with a second user; and
assign a fourth machine to provide input/output functionality for the second operating system session at the first machine.

4. The system of claim 3, wherein the server computer system is further configured to:
instruct the first machine to communicate with the fourth machine to implement input/output functionality for the second operating system session at the fourth machine.

5. The system of claim 1, wherein the server computer system is further configured to:
identify the first user prior to mapping the input/output functionality provided by the first machine to the operating system session associated with the first user at the second machine;
wherein the authenticating the first user at the first machine occurs after the mapping the input/output functionality provided by the first machine to the operating system associated with the first user at the second machine.

6. A method of providing a distributed virtual desktop, the method comprising:
authenticating a first user at a first machine communicatively coupled with a server computer system;
selecting a second machine communicatively coupled with the server computer system to host an operating system session associated with the first user;
assigning input/output functionality for the operating system session associated with the first user to the first machine; and
instructing the first machine to communicate with the second machine such that the input/output functionality provided by the first machine is mapped to the operating system session associated with the first user at the second machine.

7. The method of claim 6, further comprising:
identifying the first user prior to mapping the input/output functionality provided by the first machine to the operating system session associated with the first user at the second machine;
wherein the authenticating the first user at the first machine occurs after the mapping the input/output functionality provided by the first machine to the operating system associated with the first user at the second machine.

8. The method of claim 6, further comprising:
determining that the first user has logged out of the operating system session; and
removing a mapping between the input/output functionality of the first machine and the operating system session of the second machine.

9. The method of claim 8, further comprising:
allowing the second machine to continue running the operating system session.

10. The method of claim 8, further comprising:
authenticating the first user at a third machine; and
instructing the third machine to communicate with the second machine such that the input/output functionality provided by the third machine is mapped to the operating system session of the second machine.

11. The method of claim 6, further comprising:
selecting the first machine to host a second operating system session associated with a second user; and
assigning a fourth machine to provide input/output functionality for the second operating system session at the first machine.

12. The method of claim 11, further comprising:
instructing the first machine to communicate with the fourth machine to implement input/output functionality for the second operating system session at the fourth machine.

13. The method of claim 6, wherein the selecting the second machine to host the operating system session associated with the first user comprises:
determining that the operating system session is already in existence and hosted at the second machine; and
allowing the second machine to continue hosting the operating system session associated with the first user.

14. The method of claim 6, further comprising:
instructing the second machine to instantiate the operating system session associated with the first user.

15. The method of claim 6, further comprising:
maintaining a record at a data store of the selection of the second machine to host the operating system session associated with the first user and the assignment of the first machine to provide input/output functionality for the operating system session at the second machine.

16. A method of providing distributed virtual desktops, the method comprising:
receiving login credentials from a first user at a first machine;
communicating with a server computer system to authenticate the user based on the login credentials;
receiving a selection by the server computer system of a second machine to host an operating system session associated with the first user; and
communicating with the second machine to map input/output functionality provided at the first machine to the operating system session associated with the first user at the second machine.

17. The method of claim 16, further comprising:
hosting an operating system session associated with a second user at the first machine while the input/output functionality of the first machine is mapped to the operating system session associated with the first user at the second machine.

18. The method of claim 17, further comprising:
communicating with a third machine to map input/output functionality of the third machine to the operating system session associated with the second user.

19. The method of claim 18, further comprising:
receiving notification that the second user has logged off of the third machine; and
removing the mapping between the input/output functionality of the third machine and the operating system session associated with the second user.

20. The method of claim 19, further comprising:
continuing to run the operating system session associated with the second user after removing the mapping between the input/output functionality of the third machine and the operating system session associated with the second user.

21. The method of claim 17, further comprising:
allowing the first user to log off of the first machine;
notifying the server computer system that the first user has logged off of the first machine; and
removing the mapping between the input/output functionality of the first machine and the operating system session associated with the first user.

22. The method of claim 17, wherein the input/output functionality of the first machine comprises keyboard video mouse (KVM) functionality.
